(19) United States
(12) Patent Application Publication
(10) Pub. No.: US 2015/0365743 A1
(43) Pub. Date: Dec. 17, 2015

(54) METHOD AND APPARATUS FOR INCLUDING SOUND FROM AN EXTERNAL ENVIRONMENT INTO A VEHICLE AUDIO SYSTEM

(71) Applicant: GM GLOBAL TECHNOLOGY OPERATIONS LLC, DETROIT, MI (US)

(72) Inventors: AMIR KONIGSBERG, HERZLIYA PITUACH (IL); TAL KOREN, HERZLIYA PITUACH (IL); ELI TZIRKEL-HANCOCK, RA'ANANA (IL)

(21) Appl. No.: 14/304,887

(22) Filed: Jun. 14, 2014

(51) Int. Cl. H04R 1/00

(52) U.S. Cl. CPC H04R 1/00; H04R 2499/13

(57) ABSTRACT

A method for producing sounds corresponding to an exterior of a source vehicle through an audio system corresponding to an interior of the source vehicle includes receiving an input audio signal corresponding to an undefined sound originating from a source within an external environment of the source vehicle and determining the undefined sound to be indicative of a specific external sound to be produced at a desired loudness by one or more output sound devices located within an internal cabin of the source vehicle. An output audio signal is generated based upon the input audio signal and a desired loudness for the specific external sound to be produced. The output audio signal is transmitted to the one or more output sound devices located within an internal cabin of the source vehicle to produce the specific external sound mixed in combination with internal sound that originates from one or more infotainment sources.

### TECHNICAL FIELD

This disclosure is related to producing sounds corresponding to an exterior of a source vehicle through an interior audio system.

### BACKGROUND

The statements in this section merely provide background information related to the present disclosure. Accordingly, such statements are not intended to constitute an admission of prior art.

Occupants located within an internal cabin, e.g., passenger compartment, of a vehicle can listen to internal sounds, such as music, navigational instructions, and telephone communications, produced by an audio system of the vehicle. Internal sounds can further include conversations between occupants of the vehicle, roadway noises from passing vehicles, roadway infrastructure, weather, etc. However, these latter sounds and noises are shut-out from penetrating into the internal cabin and from being heard by the occupants of the vehicle due to closed windows and the internal sounds of the vehicle. Additionally, vehicles are often designed with the objective of isolating sounds exterior to the vehicle from the internal cabin.

While restricting sounds from the external environment of the vehicle reduces the chance of annoying (or overloading) occupants of the vehicle, restricting too much sound from the external environment can result in a driver of the vehicle not being aware of certain situations or occurrences that the driver desires to be aware of. For example, it would be desirable for the driver to hear a motorcycle travelling in a blind spot of the vehicle so that the driver does not collide with the motorcycle when making a lane change. Sound capturing devices, such as microphones, can be utilized for capturing sounds within the internal cabin of the vehicle. Further, sounds captured by sound capturing devices that are faint, or at an otherwise low level of loudness, can be amplified.

### SUMMARY

A method for producing sounds corresponding to an exterior of a source vehicle through an audio system corresponding to an interior of the source vehicle includes receiving an input audio signal corresponding to an undefined sound originating from a source within an external environment of the source vehicle and determining the undefined sound to be indicative of a specific external sound to be produced at a desired loudness by one or more output sound devices located within an internal cabin of the source vehicle. An output audio signal is generated based upon the input audio signal and a desired loudness for the specific external sound to be produced. The output audio signal is transmitted to the one or more output sound devices located within an internal cabin of the source vehicle to produce the specific external sound mixed in combination with internal sound that originates from one or more infotainment sources.

### BRIEF DESCRIPTION OF THE DRAWINGS

One or more embodiments will now be described, by way of example, with reference to the accompanying drawings, in which:

FIG. 1 illustrates an exemplary source vehicle equipped with an audio system control module, in accordance with the present disclosure;

FIG. 2 illustrates a non-limiting example of various sounds originating from one of an external environment and an internal environment of a source vehicle, in accordance with the present disclosure;

FIG. 3 illustrates a non-limiting example of the HMI device 160 of FIG. 1, in accordance with the present disclosure;

FIG. 4 illustrates an exemplary block diagram of components of an audio sound control module (ASCM) 170 of FIG. 1, in accordance with the present disclosure;

FIG. 5 illustrates an exemplary flowchart for producing sounds corresponding to an exterior of the source vehicle 100 of FIG. 1 through the interior audio system, in accordance with the present disclosure; and

FIG. 6 illustrates a non-limiting example depicting a method for partitioning an output audio signal based on a position of a source from which a specific external sound originated from in relation to a source vehicle, in accordance with the present disclosure.

### DETAILED DESCRIPTION

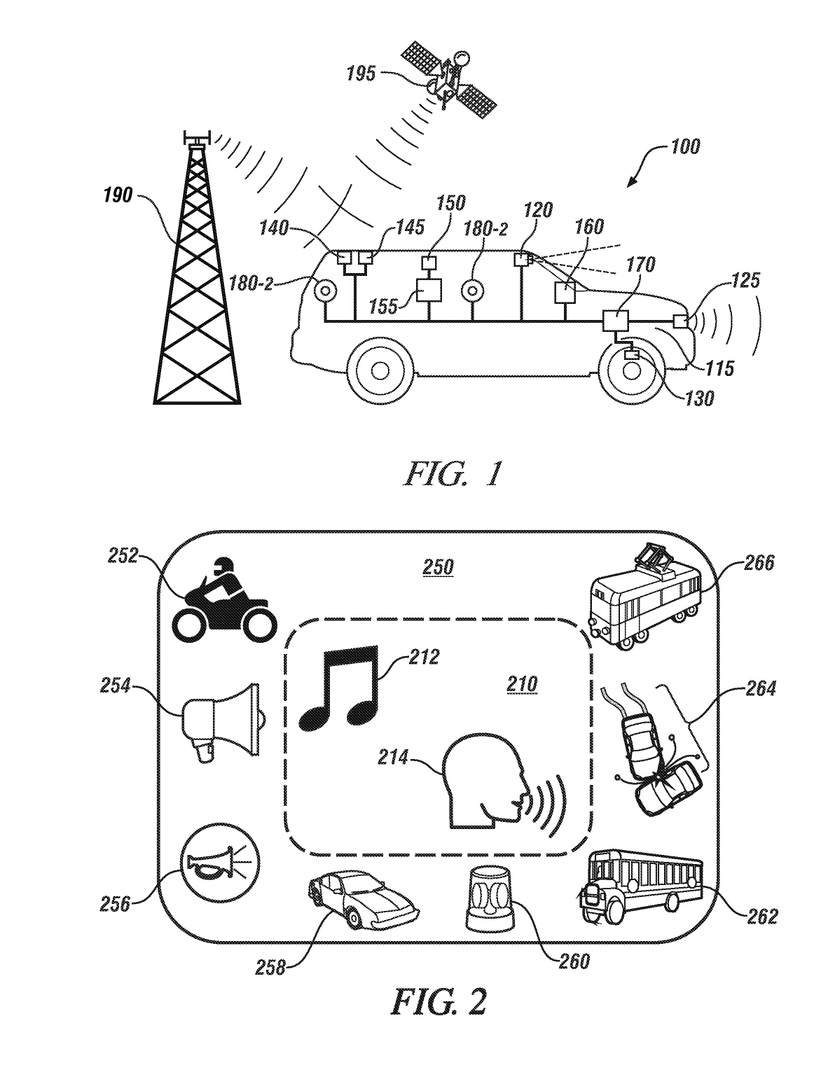

Referring now to the drawings, wherein the showings are for the purpose of illustrating certain exemplary embodiments only and not for the purpose of limiting the same, FIG. 1 illustrates an exemplary source vehicle 100 equipped with an internal audio system, in accordance with the present disclosure. Source vehicle includes an audio system control module (ASCM) 170; object detection devices, including a camera device 120 and a range device 125; sound capturing device 150 and amplifier 155; vehicle operation sensors, including vehicle speed sensor 130; information devices, including GPS device 140 and wireless communication device 145; output sound devices 180-1 and 180-2; and a human machine interface (HMI) device 160. The ASCM 170 includes a programmable processing device including programming to determine whether or not a received input audio signal, corresponding to an undefined sound originating from a source within an external environment of the source vehicle, is indicative of a specific external sound to be produced at a desired loudness within an internal cabin of the vehicle 100. As used herein, the term “external environment” refers to an operational environment exterior of—or outside of—the internal cabin of the source vehicle 100. The term “internal cabin” refers to a passenger compartment at an interior of the vehicle. The ASCM 170 may communicate directly with systems, devices and components of the source vehicle, or the ASCM 170 may alternatively or additionally communicate over a LAN/CAN system 115.

The sound capturing device 150 captures an undefined sound originating from a source within the external environment of the source vehicle and converts the undefined sound to an input audio signal that is ultimately received by the ASCM 170. As used herein, the term “sound capturing device” refers to an acoustic-to-electric transducer or sensor, such as a microphone, that converts sound in air to an electrical signal (e.g., input audio signal). The sound capturing device 150 is not limited to any one specific device capable of capturing sounds within the external environment. In some implementations, the sound capturing device 150 is positioned on the exterior of the source vehicle 100. In other implementations, the sound capturing device 150 advantageously corresponds to an existing sound capturing device that is positioned within the internal cabin for receiving speech inputs by the user of the vehicle. Speech inputs can be received for communicating with the HMI device 160, such as speaking over a telephone and commanding a desired functionality of one or more infotainment sources of the source vehicle 100. This disclosure is not limited to a single sound capturing device 150, and may include multiple sound capturing devices 150 positioned in any combination for capturing undefined sounds within the external environment of the source vehicle 100. The amplifier 155 can be utilized to amplify the input audio signal. In some implementations, the amplifier 155 may be configured to amplify input audio signals corresponding to undefined sounds originating from a source in a specified direction within the external environment.

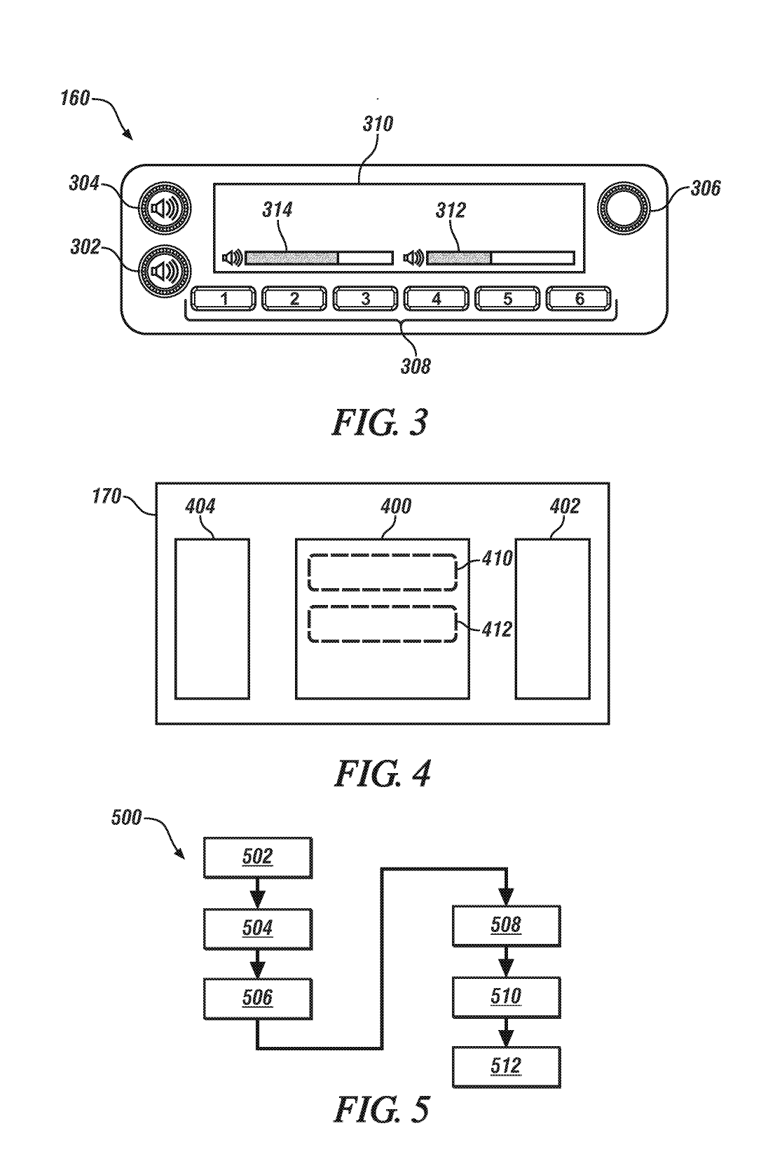

The ASCM 170 generates an output audio signal corresponding to a specific external sound if the input audio signal received from the sound capturing device 150 is determined to be indicative of the specific external sound. Discussed in greater detail with reference to the non-limiting example illustrated in FIG. 3, the HMI device 160 can receive a user input indicating a desired loudness of a specific external sound to be produced by the output sound devices 180-1 and 180-2. The output sound devices 180-1 and 180-2 are located within the internal cabin of the vehicle and correspond to existing output sound devices of the internal audio system of the source vehicle. As used herein, the term “output sound device” refers to an electro-acoustic transducer, such as a loud speaker, that produces sound in response to an electrical audio signal (e.g., output audio signal). Exemplary implementations are directed toward the ASCM 170 transmitting the output audio signal to the output sound devices 180-1 and 180-2 to produce the specific external sound mixed in combination with the internal sound that originates from one or more infotainment sources (e.g., radio, satellite, telephone, navigation, etc.). The output sound devices 180-1 and 180-2 are depicted for illustrations purposes only, and implementations herein may include any combination of one or more output sound devices 180-1 and 180-2. For instance, the internal audio system may include four or more output sound devices.

The ASCM 170 may receive inputs from one or more of an object detection device (camera device 120 and/or range device 125), GPS device 140, wireless communication device 150, and vehicle operation sensors for (1) detecting an object indicating a classified source within the external environment of the source vehicle at which an undefined sound is originated from, and (2) determining a position of the detected object in relation to the source vehicle 100. The camera device 120 includes a camera or image capturing device taking periodic or sequential images representing a view from the vehicle. The range device 125 includes a device to detect other vehicles or objects located near the source vehicle 100. The range device 125 can be used to determine a range from the source vehicle 100 to a detected object. The range device 125 may include a radar device, lidar device, or combination thereof. The camera device 120 and range device 125 can be referred to as an object detection device, and may be used together or separately, to detect, track and/or determine a range to an object of interest. A number of known in-vehicle sensors are widely used within a vehicle to monitor vehicle speed, engine speed, wheel slip, and other parameters that indicate the operation of the vehicle. Vehicle speed sensor 130 corresponds to one such in-vehicle sensor, but the scope of the disclosure includes any such sensors for use by the ASCM 170. GPS and wireless communication devices 140, 150, respectively, communicate with resources outside of the vehicle, for example, satellite system 195 and cellular communications tower 190. GPS device 140 may be utilized in conjunction with a 3D map database including detailed information indicating a global coordinate received by the GPS device 140 regarding the current location/position of the source vehicle. The wireless communication device 145 may be utilized for vehicle to vehicle communication, and in some implementations, the wireless communication device 145 can be utilized to update databases associated with the ASCM 170.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 100 microseconds, 3.125, 6.25, 12.5, 25 and 100 milliseconds during ongoing engine and vehicle operation. Alternatively, routines may be executed in response to occurrence of an event.

FIG. 2 illustrates a non-limiting example of various sounds originating from one of an external environment and an internal environment of a source vehicle, in accordance with the present disclosure. A first zone 210 corresponds to the internal environment of the source vehicle. The term “internal environment” refers to the internal cabin of the source vehicle depicting the passenger compartment where occupants of the vehicle reside. The terms “internal environment” and “internal cabin” will be used interchangeably herein. Sounds within the internal environment generally include audio 212 produced by the internal audio system from infotainment sources such as, but not limited to, music, navigational instructions and telephone conversations. Conversations 214 between occupants within the vehicle can also be indicative of sounds within the first zone 210 corresponding to the internal environment.

A second zone 250 corresponds to the external environment of the source vehicle. The term “external sounds” refer to sounds originating from the external environment that are indicative of sounds that occupants of the source vehicle would hear if the occupants were outside of the source vehicle instead of being located within the internal cabin. These external sounds may originate from a plurality of non-inclusive sources within the external environment, including, but not limited to, a motorcycle 252, announcements 254, music 256, other vehicles 258, sirens of emergency vehicles 260, school buses 262, collisions 264 and trains 266. Generally, external sounds are restricted from being heard by the user due to closed windows and internal sounds such as conversations and audio produced by the internal audio system. However, external sounds can beneficially provide the user of the vehicle with information about the immediate external environment. Too much external sound entering the vehicle can be annoying and overloading to occupants of the vehicle whereas too much external sound restricted from entering the vehicle can result in a user being unaware of information that may be pertinent. Exemplary implementations herein are directed toward only providing specific external sounds within the internal cabin of the source vehicle in a manner that provides pertinent information about the immediate external environment while restricting information from the immediate external environment that is not pertinent.

FIG. 3 illustrates a non-limiting example of the HMI device 160 of FIG. 1, in accordance with the present disclosure. In the illustrated non-limiting example, the HMI device 160 includes a display screen 310 including first and second graphics 312 and 314, respectively, indicating magnitudes of desired loudness being produced by the internal audio system. The HMI device 160 further includes control buttons 302-308 that receive a user input for controlling the HMI device 160 or controlling sound produced by one or more output sound devices of the internal audio system. As used herein, the term “button” may include a button that can be pressed, a dial that can be rotated, touch sensitive screen or pad, or a combination thereof. While the non-limiting HMI device 160 in the illustrated example includes physical buttons 302-308, the HMI device 160 may alternatively or additionally include a graphical user interface (GUI) that displays graphical elements indicating the buttons that are capable of receiving the user input when touched. In some implementations, the buttons 302-308 may alternatively or additionally be positioned on an instrument panel or steering wheel of the source vehicle. In some implementations, user inputs can be executed by speech commands, gestures, blinking and/or direction of the user's gaze instead of touching, turning or pressing the buttons 302-308.

When pressed, an internal sound button 302 receives the user input indicating a desired loudness for a specific external sound to be produced within the internal cabin by the internal audio system. The ASCM 170 of FIG. 1 may receive the user input indicating the desired loudness for the specific external sound. The first graphic 312 is displayed in response to the user input to the internal sound button 302 in the illustrated non-limiting example. In some implementations, the first graphic 312 indicates the magnitude of desired loudness corresponding to all specific external sounds produced by the internal audio system. In other implementations, the first graphic 312 indicates the magnitude of desired loudness corresponding to one specific external sound originating from a selected source within the external environment. For instance, a user input may be received by an auxiliary button/dial 306 to access a menu for selecting a plurality of sources having different classifications, and thereafter indicate the desired loudness for each source utilizing the user input received by the internal sound button 302.

When pressed, an internal sound button 304 receives the user input indicating a desired loudness for internal sound to be produced within the internal cabin by the internal audio system. As used herein, the term “internal sound” refers to sounds originating from one or more infotainment sources of the source vehicle. The ASCM 170 of FIG. 1 may receive the user input indicating the desired loudness for the specific internal sound. The second graphic 314 is displayed in response to the user input to the internal sound button 304 in the illustrated non-limiting example. In some implementations, the second graphic 314 may indicate the magnitude of loudness corresponding to a combined loudness or mix of internal and external sounds (e.g., a master volume indicator) produced by the internal audio system. In some implementations, the second graphic 314 may indicate the magnitude of desired loudness corresponding only to the internal sounds originating by one or more infotainment devices of the vehicle. Accordingly, the user of the source vehicle may customize the internal audio system via the HMI device 160 such that the one or more output sound devices located within the internal cabin of the source vehicle may produce the specific external sound at the desired loudness mixed in combination with internal sound at the desired loudness.

Referring now to FIG. 4, a block diagram illustrating the exemplary ASCM 170 of FIG. 1 is depicted, in accordance with the present disclosure. In the illustrated example, the ASCM 170 includes a processing device 400, a communication device 402 and a memory device 404.

The processing device 400 executes an external sound module 410 and an audible alert module 412. The external sound module 410 receives the input audio signal from the sound capturing device 150 of FIG. 1. The input audio signal may be amplified by the amplifier 155 prior to being received at the external sound module 410. The input audio signal may be transmitted to the external sound module 410 directly or via the LAN/CAN network 115 of FIG. 1. The external sound module 410 determines whether or not the input audio signal indicates a specific external sound to be produced at a desired loudness within the internal cabin of the source vehicle 100. As described above with reference to the non-limiting example illustrated in FIG. 3, the HMI device 160 may receive a user input indicating the desired loudness for the specific external sound to be produced and transmit the user input to the external sound module 410. Moreover, the desired loudness for the specific external sound may be a function of the desired loudness of the internal sound originating from one or more infotainment devices. In some implementations, the desired loudness can be based upon a source-dependent weighted factor assigned to the source from which the specific external sound originates.

In some implementations, the external sound module 410 determines the input audio signal indicates the specific external sound by comparing the input audio signal to a plurality of prospective audio signals stored within an audio signal database at the ASCM 170. Here, each prospective audio signal corresponds to a different prospective external sound selected to be produced through the internal audio system. For instance, the user may utilize the HMI device 160 to select predetermined prospective audio signals that the user deems as important, or otherwise interested in hearing. Likewise, the manufacturer of the source vehicle may select predetermined prospective audio signals. Additionally, the prospective audio signals stored within the audio signal database may be learned by a training set of audio signals that occur regularly and then selected by the user for storage within the audio signal database. Thereafter, the external sound module 410 may determine the undefined sound to be indicative of the specific external sound when the input audio signal matches one of the prospective audio signals. If the input audio signal does not match one of the prospective audio signals, the specific external sound will not be indicated or produced through the internal audio system. As a result, non-pertinent external sounds are filtered out from being produced through the internal audio system. The audio signal database may be maintained by the user of the source vehicle 100 or a manufacturer of the source vehicle. Prospective audio signals can be added to the audio signal database via downloading or data conversion.

In some implementations, the external sound module 410 determines the input audio signal indicates the specific external sound by obtaining a classification of the source at which the undefined sound is originated from using the input audio signal. Here, the prospective audio signals may each be assigned a respective classification stored within the audio signal database and retrieved by the input audio signal to obtain the classification of the source. In other words, the specific external sound to be produced can be selected by the user by identifying the specific classification of the source that originates the specific external sound. Thereafter, the object detection device (e.g., camera device 120 and range device 125) detects an object indicating the classified source within the external environment. For instance, audio signals corresponding to warning sirens may be associated with a classified source such as an ambulance whereat the object detection device attempts to detect an object or feature indicative of the ambulance. Additionally or alternatively, the wireless communications device 145 can be utilized to detect the object indicating the classified source based upon vehicle-to-vehicle communication. For instance, the source vehicle 100 can receive a notification from the ambulance en route to an accident indicating that the sirens are on and/or geometric coordinates of the ambulance. The position of the source vehicle can be obtained using the GPS device 140 and vehicle operational sensors as described above with reference to FIG. 1, and a position of the detected object in relation to the source vehicle can be determined. As used herein, the term “position of the detected object” can refer to a location of the detected object at a given point in time, or can refer to a trajectory of the detected object with respect to the position or a trajectory of the source vehicle. Thresholds may be utilized to define the detected object as a threat if the detected object is in close proximity to the source vehicle 100 or is predicted to be a threat to the source vehicle. Thus, the external sound module 410 may determine the undefined sound to be indicative of the specific external sound when the position of the detected object violates a threshold condition. Accordingly, when the detected objects are not perceived as threats, the corresponding input audio signal will not be indicated as a specific external sound for production within the internal cabin of the source vehicle so that the user/operator of the source vehicle is not distracted with unwanted or non-threatening external sounds.

In some implementations, the classification of the source at which the undefined sound is originated from can further be obtained from the audio signal database using the input audio signal for determining the desired loudness for the specific external sound. Some specific external sounds may be more important or urgent than others, requiring the user's prompt attention. For instance, and in a non-limiting example, a collision in an adjacent lane of the source vehicle can be deemed more urgent than a motorcycle travelling in the adjacent lane of the source vehicle. Accordingly, specific external sounds can be weighted based upon the classification of the source at which the undefined sound originates. Here, the classified source obtained from the audio signal database can be used to retrieve a source-dependent weighted factor from a weighting factor database. The weighting factor database can include a plurality of source-dependent weighted factors ranging from low importance to high importance whereat each factor is associated with—and assigned to—one or more sources. In some implementations, the audio signal database can further assign each classification the source-dependent weighted factor. Accordingly, the desired loudness for the specific external sound can be determined based upon the retrieved source-dependent weighted factor. In the non-limiting example, the collision in the adjacent lane can include a high source-dependent weighted factor resulting in a higher magnitude of desired loudness than that of the motorcycle traveling in the adjacent lane.

The external sound module 410 generates an output audio signal based on the input audio signal and the desired loudness for the specific external sound to be produced when the input audio signal indicates the specific external sound. Thereafter, the generated output audio signal is transmitted to the at least one output sound device 180-1 and/or 180-2 located within the internal cabin of the source vehicle. While the non-limiting illustrated example of FIG. 1 depicts two output sound devices (e.g., speakers) 180-1 and 180-2, it will be understood that the exemplary source vehicle 100 can include any number and configuration of output sound devices for producing audio within the internal cabin of the source vehicle.

In some implementations, the transmitted output audio signal to at least one output sound device 180-1 and 180-2 is partitioned by the external sound module 410 such that the specific external sound is produced from a direction that conveys a position of the source from which the specific external sound originated from in relation to the source vehicle. For instance, when the specific external sound is indicative of warning sirens originating from an emergency response vehicle, the warning sirens can be partitioned through the internal audio system of the source vehicle such that a portion of the specific external sound (e.g., sirens) is produced by a rear-left side output sound device in the internal cabin of the source vehicle and a remaining portion of the specific external sound is produced by a rear-right side output sound device when the emergency response vehicle includes a position that is behind the source vehicle. As aforementioned, the source of the external sound and the position of the source can be determined by obtaining the classification of the source from the audio signal database and using the object detection device to detect the source and the position of the source.

Conventionally, the internal audio system produces internal sounds originating from an infotainment source. The term “internal audio system” can collectively refer to one or more of the HMI device 160, the sound capturing device 150 and the output sound devices 180-1 and 180-2. The internal sounds are described above with reference to the non-limiting example illustrated in FIG. 2. The ASCM 170 is operative to mix the specific external sound in combination with the internal sound such that the at least one output sound device produces both the specific external sound and the internal sound in combination and simultaneously. A desired mix or balance between the internal sound and the specific external sound can be selected by the user based upon user inputs to the HMI device 160, as described above with reference to the non-limiting example illustrated in FIG. 3.

In further implementations, the amplifier 155 can be utilized to amplify the input audio signals captured by the sound capturing device 150 of the exemplary source vehicle 100 of FIG. 1. Amplification of audio signals can be beneficial to obtain low or soft undefined sounds within the external environment that may be important to—and require the attention of—the user of the source vehicle. Moreover, the ASCM 170 may be configured to only amplify input audio signals corresponding to undefined sounds from a selected limited direction. For instance, and in a non-limiting example, input audio signals corresponding to undefined sounds captured from a direction within the “blind spot” of the source vehicle can be amplified. The user may select the direction that input audio signals are amplified by using the HMI device 160. In another non-limiting example, input audio signals corresponding to undefined sounds captured from a direction behind the source vehicle can be amplified when a gear selector lever is in reverse or the source vehicle is otherwise determined to be traveling in a reversed direction.

Still referring to FIG. 4, the audible alert module 412 executed by the processing device 400 of the ASCM 170 can be utilized to detect any object or feature indicating a potentially hazardous condition within the external environment independent of sound. For instance, a pot hole on the roadway traveled by the source vehicle or a child playing near the roadway can be deemed a potentially hazardous condition requiring the user/operator's attention. The audible alert module 412 utilizes the object detection device to iteratively detect potentially hazardous objects or features, and then determine a position of the detected object or feature in relation to the source vehicle. Thereafter, a warning audio signal corresponding to an audible alert at a desired loudness based on the detected object and the position of the detected object can be generated. The warning audio signal is transmitted to the at least one output sound device for producing the audible alert at the desired loudness. For instance, the desired loudness of the pothole would be lower if the pothole includes a position on a shoulder of the roadway than if the pothole included a position in the current lane of travel of the source vehicle. Likewise, the desired loudness of the audible alert can intensify as the position between the pothole and the source vehicle decreases. In some implementations, the audible alert is produced by the at least one output sound device from a direction within the internal cabin that conveys the position of the detected object in relation to the source vehicle. Production of the audible alert from the direction that conveys the position of the detected object can be executed by the audible alert module 412 in a manner analogous to how the external sound module 410 partitions the output audio signal to convey the position of the classified source originating the specific external sound.

The communication device 402 is a device that allows the ASCM 170 to communicate with systems, devices and components (e.g., features 140, 145, 120, 160, 125, 140, 160, 180, 190 and 195) of the source vehicle 100 of FIG. 1 directly, or via the LAN/CAN 115 system. The communication device 402 can include one or more wireless transceivers for performing wireless communication and/or one or more communication ports for performing wired communication.

The memory device 404 is a device that stores data that is generated or received by the ASCM 170. The audio signal and weighted factor databases, or similar structures, can be stored in the memory device 404. The user or vehicle manufacturer may maintain the databases stored in the memory device 404. Databases can be removed and additional databases can be stored within the memory device 404

Referring now to FIG. 5, an exemplary flowchart 500 is illustrated for producing sounds corresponding to an exterior of the source vehicle 100 of FIG. 1 through the interior audio system, in accordance with the present disclosure. The exemplary flowchart 500 can be described with reference to FIG. 1 and implemented within—and executed by—the ASCM 170 of the source vehicle 100. Table 1 is provided as a key to FIG. 5 wherein the numerically labeled blocks and the corresponding functions are set forth as follows.

TABLE 1

| BLOCK | BLOCK CONTENTS |
|---|---|
| 502 | Start. |
| 504 | Receive an input audio signal corresponding to an undefined |
| | sound originating from a source within an external |
| | environment of the source vehicle. |
| 506 | Determine the undefined sound to be indicative of a specific |
| | external sound to be produced at a desired loudness by one or |
| | more output sound devices within an internal cabin of the |
| | source vehicle. |
| 508 | Generate an output audio signal based upon the input audio |
| | signal and a desired loudness for the specific external sound |
| | to be produced. |
| 510 | Transmit the output audio signal to the one or more output |
| | sound devices located within an internal cabin of the source |
| | vehicle to produce the specific the specific external sound |
| | mixed in combination with internal sound that originates |
| | from one or more infotainment sources. |
| 512 | End. |

The exemplary flowchart 500 starts at block 502 and proceeds to block 504 whereat the flowchart 500 receives an input audio signal corresponding to an undefined sound originating from a source within an external environment of the source vehicle. The sound capturing device 150, e.g., microphone, captures the undefined sound and converts the undefined sound to the input audio signal. The input audio signal is transmitted to the ASCM 170.

Block 506 determines the undefined sound to be indicative of a specific external sound to be produced at a desired loudness by one or more output sound devices located within an internal cabin of the source vehicle. The input audio signal may be amplified in some implementations. When the input audio signal matches one of a plurality of prospective audio signals stored within an audio signal database, the ASCM 170 may determine the undefined sound to be indicative of the specific external sound. In another implementation, the ASCM 170 may determine the undefined sound to be indicative of the specific external sound when a detected object that originates the undefined sound is determined to violate a threshold condition. For instance, a train whistle can be indicative of the specific external sound when the train is in close proximity of the source vehicle. Likewise, a thumping sound of a preceding vehicle that hits a road obstruction in close proximity of the vehicle can be indicative of the specific external sound.

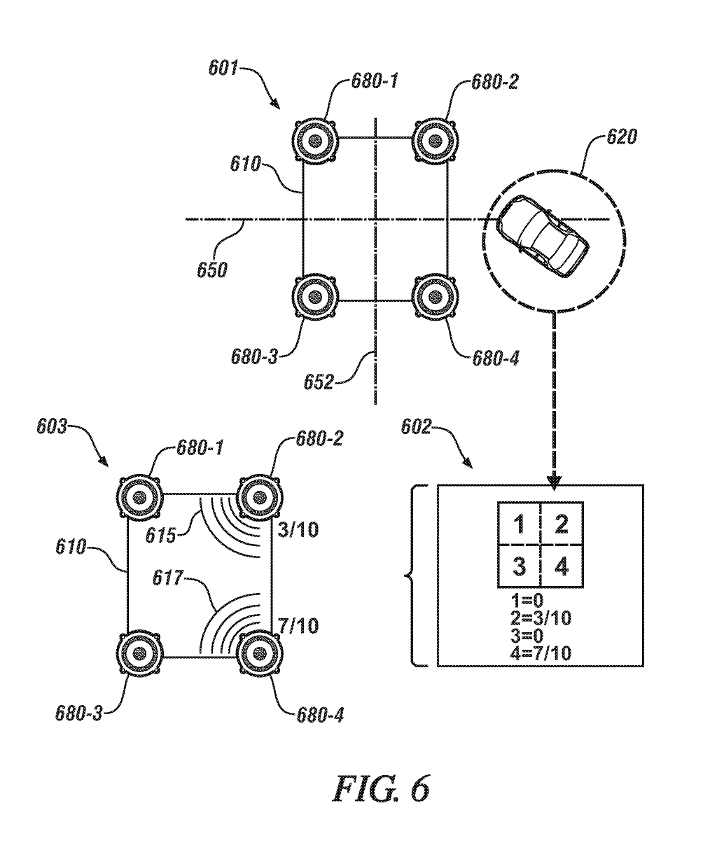

Block 508 generates an output audio signal based upon the input audio signals and the desired loudness for the specific external sound to be produced. The specific external sound can be produced by one or more output sound devices (e.g., output sound devices 180-1 and 180-2 of FIG. 1) so that information about the relative position of the source originating the specific external sound is provided to the user of the source vehicle. Referring to FIG. 6, a non-limiting example is shown that depicts a method for partitioning the output audio signal based on the position of the source from which the specific external sound originated from in relation to the position of the source vehicle. A first step 601 includes partitioning the internal environment within a box 610 and the external environment outside of the box 610, into four equally-sized quadrants based on dashed horizontal line 650 and dashed vertical line 652. This disclosure is not limited to four quadrants, and may include any desirable number of areas for partitioning the internal environment with respect to the external environment. Output sound devices within the internal cabin of the source vehicle include a front-left speaker 680-1, a front-right speaker 680-2, a rear-left speaker 680-3 and a rear-right speaker 680-4. Dashed circle 620 represents a vehicle with respect to the source vehicle that has been detected by the detection device. For instance, the range device 125 of FIG. 1 may detect the position of the vehicle with respect to the source vehicle. In the non-limiting example, the detected vehicle within dashed circle 620 originates a specific external sound to be produced by the speakers 680-1 thru 680-4.

A second step 602 determines what portions of the detected vehicle are positioned within one or more of the four partitioned quadrants. In the illustrated non-limiting example, the detected vehicle is not positioned in either of the first and third quadrants, as denoted by a “1=0” and a “3=0”. About 30% (3/10) of the detected vehicle is positioned in the second quadrant and about 70% (7/10) of the detected vehicle is positioned in the fourth quadrant.

A third step 603 illustrates audio waves 615 and 617 representing the specific external sound originated by the detected vehicle and produced by respective ones of the front-right and rear-right speakers 680-2, 680-4, respectively, at the desired loudness. Here, the speakers produce the specific external sound from a direction that conveys a position of the source (e.g., detected vehicle) from which the specific external sound originated from in relation to the source vehicle. The total loudness produced by speakers 680-2 and 680-4 is equal to the desired loudness. In the illustrated example, the front-right speaker 680-2 produces about 3/10 of the specific external sound and the rear-right speaker 680-4 produces about 7/10 of the specific external sound based on the generated output signal. The audio waves produced by the speakers may dynamically pan to convey changes in position of the detected vehicle in relation to the source vehicle. The speakers may produce more than one specific external sound simultaneously, each corresponding to a respective detected object and a position for each respective detected object.

Referring now to block 510, the ASCM 170 transmits the output audio signal to the one or more output sound devices located within the internal cabin of the source vehicle to produce the specific external sound mixed in combination with internal sound that originates from one or more infotainment devices. In the non-limiting example of FIG. 6, step 603 illustrates the output audio signal transmitted to the front-right and rear-right speakers 680-2, 680-4, respectively, whereat the output audio signal is portioned such that the front-right speaker 680-2 produces 3/10 of the specific external sound and the rear-right speaker 680-4 produces 7/10 of the specific external sound. As used herein, the term “mixed in combination” refers to both the specific external sound produced at the desired loudness and the internal sound produced at a desired loudness by the one or more output sound devices simultaneously. The “mix” of the desired loudness for each of the external sound and the internal sound can be controlled via user inputs to the HMI device 160, as described above with reference to the non-limiting example of FIG. 3. Additionally or alternatively, the desired loudness for each of the external and internal sounds can be increased or decreased based on changes in the operational environment of the source vehicle 100. For instance, the loudness may be increased to compensate for disturbances in the loudness such as when it is raining or when the vehicle is travelling at high speeds. Likewise, the desired loudness for the external sound can be based upon the source-dependent weighted factor of the source that originates the external sound. The exemplary flowchart 500 ends at block 512.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for producing sounds corresponding to an exterior of a source vehicle through an audio system corresponding to an interior of the source vehicle, comprising:
receiving an input audio signal corresponding to an undefined sound originating from a source within an external environment of the source vehicle;
determining the undefined sound to be indicative of a specific external sound to be produced at a desired loudness by one or more output sound devices located within an internal cabin of the source vehicle;
generating an output audio signal based upon the input audio signal and the desired loudness for the specific external sound to be produced; and
transmitting the output audio signal to the one or more output sound devices to produce the specific external sound mixed in combination with internal sound that originates from one or more infotainment sources.

2. The method of claim 1, further comprising:
obtaining a user input indicating the desired loudness for the specific external sound to be produced through the one or more output sound devices.

3. The method of claim 2, wherein the desired loudness for the specific external sound is further based upon a function of a desired loudness of the internal sound produced by the one or more output sound devices.

4. The method of claim 1, wherein determining the undefined sound to be indicative of the specific external sound comprises:
comparing the input audio signal to a plurality of prospective audio signals stored within an audio signal database, each prospective audio signal corresponding to a different prospective external sound selected to be produced; and
determining the undefined sound to be indicative of the specific external sound when the input audio signal matches one of the prospective audio signals.

5. The method of claim 4, wherein the prospective audio signals stored within the audio signal database comprise at least one of:
predetermined prospective audio signals maintained by a user of the source vehicle;
predetermined prospective audio signals maintained by a manufacture of a source vehicle; and
learned prospective audio signals using a training set of audio signals that regularly occur.

6. The method of claim 1, wherein determining the undefined sound to be indicative of the specific external sound comprises:
obtaining a classification of the source at which the undefined sound is originated from using the input audio signal;
detecting an object indicating the classified source within the external environment using an object detection device;
determining a position of the detected object in relation to the source vehicle; and
determining the undefined sound to be indicative of the specific external sound when the position of the detected object violates a threshold condition.

7. The method of claim 1, further comprising:
classifying the source at which the undefined sound is originated from using the input audio signal;
retrieving a source-dependent weighted factor from a weighting factor database using the classification of the source; and
determining the desired loudness for the specific external sound to be produced based upon the retrieved source-dependent weighted factor.

8. The method of claim 1, wherein transmitting the output audio signal to the one or more output sound devices comprises:
partitioning the transmitted output audio signal to one or more of the output sound devices to produce the specific external sound from a direction that conveys a position of the source from which the specific external sound originated from in relation to a position of the source vehicle.

9. The method of claim 1, wherein the received input audio signal corresponding to the undefined sound is amplified.

10. The method of claim 1, further comprising:
detecting an object indicating a potentially hazardous condition within the external environment using an object detection device;
determining a position of the detected object in relation to the source vehicle;
generating a warning audio signal corresponding to an audible alert at a desired loudness based on the detected object and the position of the detected object; and
transmitting the warning audio signal to the one or more output sound devices to produce the audible alert at the desired loudness from a direction that conveys the position of the detected object in relation to a position of the source vehicle.

11. An apparatus for producing sounds corresponding to an exterior of a source vehicle within an internal cabin of the source vehicle, comprising:
a sound capturing device of the source vehicle that captures an undefined sound originating from a source within an external environment of the source vehicle, the sound capturing device converting the undefined sound to an input audio signal;
an external sound module that in response to receiving the input audio signal from the sound capturing device:
determines whether or not the input audio signal indicates a specific external sound to be produced at a desired loudness within the internal cabin;
generates an output audio signal based on the input audio signal and the desired loudness for the specific external sound to be produced when the input audio signal indicates the specific external sound;
transmits the generated output audio signal to at least one output sound device located within the internal cabin; and
the least one output sound device that produces the specific external sound mixed in combination with internal sound that originates from an infotainment source.

12. The apparatus of claim 11, further comprising:
a human machine interface (HMI) device that receives a user input indicating the desired loudness for the specific external sound to be produced within the internal cabin and transmits the user input to the external sound module.

13. The apparatus of claim 12, wherein the user input indicating the desired loudness for the specific external sound is further based upon a function of a desired loudness of the internal sound produced by the at least one output sound device.

14. The apparatus of claim 11, wherein the external sound module determines the input audio signal indicates the specific external sound by:
comparing the input audio signal to a plurality of prospective audio signals stored within an audio signal database, each prospective audio signal corresponding to a different prospective external sound selected to be produced through the internal audio system; and
determining the undefined sound to be indicative of the specific external sound when the input audio signal matches one of the prospective audio signals.

15. The apparatus of claim 14, wherein the audio signal database is maintained by at least one of a user of the source vehicle and a manufacturer of the source vehicle.

16. The apparatus of claim 11, wherein the external sound module determines that the input audio signal indicates the specific external sound by:
obtaining a classification of the source at which the undefined sound is originated from using the input audio signal;
detecting an object indicating the classified source within the external environment using an object detection device;
determining a position of the detected object in relation to the source vehicle; and
determining the undefined sound to be indicative of the specific external sound when the position of the detected object violates a threshold condition.

17. The apparatus of claim 11, wherein the external sound module determines the desired loudness for the specific external sound by:
obtaining a classification of the source at which the undefined sound is originated from using the input audio signal;
retrieving a source-dependent weighted factor from a weighting factor database using the classified source; and
determining the desired loudness for the specific external sound based upon the retrieved source-dependent weighted factor.

18. The apparatus of claim 11, wherein the external sound module transmits the generated output audio signal to at least one output sound device by:
partitioning the transmitted output audio signal to the at least one output sound device such that the at least one output sound device produces the specific external sound from a direction that conveys a position of the source from which the specific external sound originated from in relation to the source vehicle.

19. The apparatus of claim 11, further comprising:
an amplifier that amplifies the input audio signal corresponding to the undefined sound.

20. The apparatus of claim 11, further comprising:
an audible alert module that:
detects an object indicating a potentially hazardous condition within the external environment using an object detection device;
determines a position of the detected object in relation to the source vehicle;
generates a warning audio signal corresponding to an audible alert at a desired loudness based on the detected object and the position of the detected object;
transmits the warning audio signal to the at least one output sound device; and
the at least one output sound device that in response to receiving the warning audio signal, produces the audible alert at the desired loudness from a direction that conveys the position of the detected object in relation to a position of the source vehicle.
